(19) United States
(12) Patent Application Publication
(10) Pub. No.: US 2026/0125566 A1
(43) Pub. Date: May 7, 2026

(54) FIREPROOF AND FLAME-RETARDANT MATERIAL BASED ON WASTE SLAG OF ALUMINUM FACTORY, PREPARATION METHOD AND APPLICATIONS THEREOF, AND FLAME-RETARDANT CABLE AND PREPARATION METHOD THEREOF

(71) Applicant: Fuzhou University, Fuzhou (CN)

(72) Inventors: Yan YU, Fuzhou (CN); Chenggong YUAN, Fuzhou (CN); Kongjian CHEN, Fuzhou (CN); Feifei CHEN, Fuzhou (CN)

(73) Assignee: Fuzhou University, Fuzhou (CN)

(21) Appl. No.: 18/976,391

(22) Filed: Dec. 11, 2024

(30) Foreign Application Priority Data
Nov. 6, 2024 (CN) 202411570779.0

(51) Int. Cl. C09D 5/18; C08K 3/22; C09D 5/02; C09D 7/40; C09D 7/61; C09D 7/80; C09D 131/04; H01B 7/295

(52) U.S. Cl. CPC C09D 5/18; C09D 5/022; C09D 5/028; C09D 7/61; C09D 7/69; C09D 7/80; C09D 131/04; H01B 7/295; C08K 2003/2224; C08K 2003/2227; C08K 2003/2293; C08K 2201/005; C08K 2201/014

(57) ABSTRACT

A fireproof and flame-retardant material based on waste slag of aluminum factory, a preparation method and applications thereof, and a flame-retardant cable and a preparation method thereof are provided. The present disclosure provides a fireproof and flame-retardant material based on waste slag of aluminum factory, measured by weight parts, including raw materials: waste slag of aluminum factory (dry weight) 1-6 phr, inorganic hydroxide 0-6 phr, VAE latex 3-8 phr, and water 20-50 phr. The present disclosure only uses water as a solvent, VAE latex as a polymer matrix, the waste slag of aluminum factory and inorganic hydroxide as fillers. The price of raw materials is low and easy to obtain. The fireproof and flame-retardant material based on the waste slag of aluminum factory has excellent flame retardant, tensile strength, elongation and gram weight.

### CROSS REFERENCE TO THE RELATED APPLICATIONS

This application is based upon and claims priority to Chinese Patent Application No. 202411570779.0, filed on Nov. 6, 2024, the entire contents of which are incorporated herein by reference.

### TECHNICAL FIELD

The present disclosure relates to the technical field of fire-retardant materials, and in particular, to a fireproof and flame-retardant material based on waste slag of aluminum factory, a preparation method and applications thereof, and a flame-retardant cable and a preparation method thereof.

### BACKGROUND

In recent years, with the rapid rise of the new energy vehicle market and the vigorous development of renewable energy industries such as photovoltaic and wind power, the demand for wire and cable products is increasing. However, the current wire and cable industry still faces some technical problems, for example, the cable tape has low mechanical properties, low flame-retardant properties, poor high-temperature resistance and oxidation resistance, and high cost. These problems not only affect the performance and service life of cable products but also restrict the further development of the industry.

The Chinese patent CN114318910A1 discloses a processing technology procedure for a halogen-free low-smoke filling rope for electrical cables, and raw materials include the following mass percentage components: magnesium hydroxide 30-60%, vinyl acetate-ethylene (VAE) emulsion 10-40%, and the rest is water. However, although the above raw materials carry out coating by using magnesium hydroxide, the elongation of the tape is relatively low.

### SUMMARY

In view of this, an objective of the present disclosure is to provide a fireproof and flame-retardant material based on waste slag of aluminum factory, a preparation method and applications thereof, and a flame-retardant cable and a preparation method thereof. The fireproof and flame-retardant material based on the waste slag of aluminum factory provided by the present disclosure has excellent flame retardancy, tensile strength and elongation.

In order to achieve the above objective, the present disclosure adopts the following technical solutions.

The present disclosure provides a fireproof and flame-retardant material based on waste slag of aluminum factory, measured by weight parts, including raw materials: waste slag of aluminum factory (dry weight) 1-6 phr, inorganic hydroxide 0-6 phr, VAE latex 3-8 phr, and water 20-50 phr.

Preferably, a component of the waste slag of aluminum factory includes one or more of boehmite, bayerite, α-alumina and β-alumina;
the waste slag of aluminum factory is dehydrated and dried before use, and then crushed and refined, to obtain dried powder of the waste slag of aluminum factory; and
a particle size of the dried powder of the waste slag of aluminum factory is 0.074-0.45 mm.

Preferably, the inorganic hydroxide includes one or more of magnesium hydroxide, aluminum hydroxide, Mg—Al layered double hydroxide and Ni—Al layered double hydroxide.

The present disclosure provides a preparation method of the fireproof and flame-retardant material based on the waste slag of aluminum factory described in the above technical solution, including the following steps: performing decentralized treatment on raw materials, to obtain a mixed solution, and drying the mixed solution, to obtain the fireproof and flame-retardant material based on waste slag of aluminum factory.

Preferably, the decentralized treatment includes ultrasonic dispersion and/or stirring dispersion;
a time of the ultrasonic dispersion is 15-60 min, and power of the ultrasonic dispersion is 80-120 W; and
a time of the stirring dispersion is 0.5-3 min, and a speed of the stirring dispersion is 500-1000 r/min.

Preferably, the drying includes one or more of room temperature drying, atmospheric heating drying and vacuum heating drying;
a time of the room temperature drying is 10-60 min;
a temperature of the atmospheric heating drying is 30-90° C., and a time of the atmospheric heating drying is 5-30 min; and
a temperature of the vacuum heating drying is 30-90° C., and a time of the vacuum heating drying is 5-30 min.

The present disclosure provides applications of the fireproof and flame-retardant material based on the waste slag of aluminum factory described in the above technical solution or the fireproof and flame-retardant material based on the waste slag of aluminum factory prepared by the preparation method described in the above technical solution.

The present disclosure further provides a flame-retardant cable, including a cable matrix and the fireproof and flame-retardant material based on waste slag of aluminum factory coated on a surface of the cable matrix.

The present disclosure provides a preparation method of the lame-retardant cable described in the above technical solution, including the following steps: performing decentralized treatment on the raw materials of the fireproof and flame-retardant material based on the waste slag of aluminum factory described in the above technical solution, to obtain a mixed solution, coating the mixed solution on the cable matrix and drying, to obtain the flame-retardant cable.

Preferably, the decentralized treatment includes ultrasonic dispersion and/or stirring dispersion;
a time of the ultrasonic dispersion is 15-60 min, and power of the ultrasonic dispersion is 80-120 W; and
a time of the stirring dispersion is 0.5-3 min, and a speed of the stirring dispersion is 500-1000 r/min; and
the drying includes one or more of room temperature drying, atmospheric heating drying and vacuum heating drying.

The waste slag of aluminum factory is sintered at high temperatures, and γ-AlOOH is transformed into α-Al₂O₃ (commonly known as corundum) irreversibly after a series of crystal transformation at different temperatures, which is an important component of fire-resistant materials. Due to the high aluminum content and ultrafine particle size of the waste slag, it can be converted into corundum at lower temperatures. The present disclosure uses the waste slag of aluminum factory as a high-temperature resistant raw material, which significantly improves the refractoriness while reducing the cost. Moreover, as a general solid waste, the landfill treatment of the waste slag of aluminum factory can cost a lot and cause a waste of resources, while converting the waste slag of aluminum factory into high-value refractory materials can avoid secondary environmental pollution and the waste of land resources due to improper disposal. The present disclosure uses the waste slag of aluminum factory as a high-temperature resistant raw material to effectively solve the problem of accumulation and treatment of the waste slag of aluminum factory, and converts the waste slag of aluminum factor into a high-value fire-resistant material, realizing the recycling of resources, which provides a high-value conversion path for the treatment of bulk industrial solid waste.

According to the present disclosure, by adding inorganic hydroxide, the fireproof and flame-retardant material based on the waste slag of aluminum factory has good flame retardant.

According to the present disclosure, by adding VAE latex as a polymer matrix, the inorganic hydroxides is combined with glass fiber cloth effectively, resulting in the fireproof and flame-retardant material based on the waste slag of aluminum factory has excellent tensile strength and elongation.

The present disclosure only uses water as a solvent, VAE latex as a polymer matrix, waste slag of aluminum factory and inorganic hydroxide as fillers. The price of raw materials is low and easy to obtain. The fireproof and flame-retardant material based on the waste slag of aluminum factory has excellent flame retardant, tensile strength, elongation and gram weight. It is used as a cable flame-retardant belt to prevent it from easily being damaged during transportation and installation, prevent the spread of fire and inhibit the release of smoke in fire.

The present disclosure provides a preparation method of the fireproof and flame-retardant material based on the waste slag of aluminum factory, the process flow is simple, the raw materials are easy to obtain and has low price, the environment is friendly, the production cost is low, and it is suitable for industrial production.

### BRIEF DESCRIPTION OF THE DRAWINGS

FIG. 1 shows an X-ray diffraction pattern of waste slag of aluminum factory; and

FIG. 2 shows thermogravimetric curves of waste slag of aluminum factory and magnesium hydroxide.

### DETAILED DESCRIPTION OF THE EMBODIMENTS

The present disclosure provides a fireproof and flame-retardant material based on waste slag of aluminum factory, measured by weight parts, including raw materials: waste slag of aluminum factory (dry weight) 1-6 phr, inorganic hydroxide 0-6 phr, VAE latex 3-8 phr, and water 20-50 phr.

If there is no special description, the materials and equipment used in the present disclosure are all commercially available products in this field.

Measured by weight parts, the raw materials of the fireproof and flame-retardant material based on the waste slag of aluminum factory include waste slag of aluminum factory (dry weight) 1-6 phr, which can be 1 phr, 2 phr, 3 phr, 4 phr, 5 phr or 6 phr in the embodiments of the present disclosure.

In the present disclosure, a component of the waste slag of aluminum factory preferably includes one or more of Boehmite (Boehmite, γ-AlOOH), Bayerite (Bayerite, Al₂O₃·3H₂O), α-alumina (activated alumina) and β-alumina.

In the present disclosure, the waste slag of aluminum factory is dehydrated and dried before use, and then crushed and refined, to obtain dried powder of the waste slag of aluminum factory.

A particle size of the dried powder of the waste slag of aluminum factory is preferably 0.074-0.45 mm, which can be 0.074 mm, 0.08 mm, 0.09 mm, 0.1 mm, 0.15 mm, 0.2 mm, 0.25 mm, 0.3 mm, 0.35 mm, 0.4 mm or 0.45 mm in the embodiments of the present disclosure.

In the present disclosure, the dehydration drying preferably includes one or more of atmospheric heating drying, vacuum heating drying and freeze-drying. In the present disclosure, a temperature of the atmospheric heating drying is preferably 30-90° C., which can be 30° C., 35° C., 40° C., 45° C., 50° C., 55° C., 60° C., 65° C., 70° C., 75° C., 80° C., 85° C. or 90° C. in the embodiments of the present disclosure; and a time of the atmospheric heating drying is preferably 1-24 h, which can be 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h or 24 h in the embodiments of the present disclosure. In the present disclosure, a temperature of the vacuum heating drying is preferably 30-70° C., which can be 30° C., 35° C., 40° C., 45° C., 50° C., 55° C., 60° C., 65° C. or 70° C. in the embodiments of the present disclosure; a time of the vacuum heating drying is preferably 1-24 h, which can be 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h or 24 h in the embodiments of the present disclosure. In the present disclosure, a temperature of the freeze-drying is preferably −40° C.-50° C., which can be −40° C., −41° C., −42° C., −43° C., −44° C., −45° C., −46° C., −47° C., −48° C., −49° C. or −50° C. in the embodiments of the present disclosure; a pressure of the freeze-drying is preferably 5-30 Pa, which can be 5 Pa, 10 Pa, 15 Pa, 20 Pa, 25 Pa or 30 Pa in the embodiments of the present disclosure; and a time of the freeze-drying is preferably 12-24 h, which can be 12 h, 13 h, 14 h, 15 h, 16 h, 17 h, 18 h, 19 h, 20 h, 21 h, 22 h, 23 h or 24 h in the embodiments of the present disclosure.

In the present disclosure, the crushing and refining treatment preferably includes one or more of grinding refining, ball-milling refining and ultrafine powder refining, and more preferably ball-milling refining. The present disclosure has no special limitation for the process conditions of grinding refinement, ball milling refinement and ultrafine powder refinement, and can obtain the dried powder of the waste slag of aluminum factory with the particle size of 0.074-0.45 mm.

The waste slag of aluminum factory is sintered at high temperatures, and γ-AlOOH is transformed into α-Al₂O₃ (commonly known as corundum) irreversibly after a series of crystal transformation at different temperatures, which is an important component of fire-resistant materials. Due to the high aluminum content and ultrafine particle size of the waste slag, it can be converted into corundum at lower temperatures. The present disclosure uses the waste slag of aluminum factory as a high-temperature resistant raw material, which significantly improves the refractoriness while reducing the cost. Moreover, as a general solid waste, the landfill treatment of the waste slag of aluminum factory can cost a lot and cause a waste of resources, while converting the waste slag of aluminum factory into high-value refractory materials can avoid secondary environmental pollution and the waste of land resources due to improper disposal. The present disclosure uses the waste slag of aluminum factory as a high-temperature resistant raw material to effectively solve the problem of accumulation and treatment of the waste slag of aluminum factory, and converts the waste slag of aluminum factor into a high-value fire-resistant material, realizing the recycling of resources, which provides a high-value conversion path for the treatment of bulk industrial solid waste.

Measured by the weight parts of the waste slag of aluminum factory (dry weight), the raw materials of the fireproof and flame-retardant material based on the waste slag of aluminum factory include inorganic hydroxide 0-6 phr, which can be 1 phr, 2 phr, 3 phr, 4 phr, 5 phr or 6 phr in the embodiments of the present disclosure. In the present disclosure, the inorganic hydroxide preferably includes one or more of magnesium hydroxide, aluminum hydroxide, Mg—Al layered double hydroxide and Ni—Al layered double hydroxide. According to the present disclosure, by adding inorganic hydroxide, the fireproof and flame-retardant material based on the waste slag of aluminum factory has good flame retardant.

Measured by the weight parts of the dried powder of the waste slag of aluminum factory, the raw materials of the fireproof and flame-retardant material based on the waste slag of aluminum factory include VAE latex 3-8 phr, which can be 3 phr, 4 phr, 5 phr, 6 phr, 7 phr or 8 phr in the embodiments of the present disclosure. According to the present disclosure, by adding VAE latex as a polymer matrix, the inorganic hydroxides is combined with glass fiber cloth effectively, resulting in the fireproof and flame-retardant material based on the waste slag of aluminum factory has excellent tensile strength and elongation.

Measured by the weight parts of the waste slag of aluminum factory (dry weight), the raw materials of the fireproof and flame-retardant material based on the waste slag of aluminum factory include water 20-50 phr, which can be 20 phr, 21 phr, 22 phr, 23 phr, 24 phr, 25 phr, 26 phr, 27 phr, 28 phr, 29 phr, 30 phr, 31 phr, 32 phr, 33 phr, 34 phr, 35 phr, 36 phr, 37 phr, 38 phr, 39 phr, 40 phr, 41 phr, 42 phr, 43 phr, 44 phr, 45 phr, 46 phr, 47 phr, 48 phr, 49 phr or 50 phr in the embodiments of the present disclosure.

The present disclosure provides a preparation method of the lame-retardant cable described in the above technical solution, including the following steps: decentralized treatment is performed on the raw materials of the fireproof and flame-retardant material based on the waste slag of aluminum factory described in the above technical solution, to obtain a mixed solution, and the mixed solution is coated on the cable matrix and dried, to obtain the flame-retardant cable.

In the present disclosure, the decentralized treatment preferably includes ultrasonic dispersion and/or stirring dispersion. In the present disclosure, a time of the ultrasonic dispersion is preferably 15-60 min, which can be 15 min, 20 min, 25 min, 30 min, 35 min, 40 min, 45 min, 50 min, 55 min or 60 min in the embodiments of the present disclosure; and power of the ultrasonic dispersion is preferably 80-120 W, which can be 80 W, 85 W, 90 W, 95 W, 100 W, 105 W, 110 W, 115 W or 120 W in the embodiments of the present disclosure. In the present disclosure, a time of the stirring dispersion is preferably 0.5-3 min, which can be 0.5 h, 1 h, 1.5 h, 2 h, 2.5 h or 3 h in the embodiments of the present disclosure; and a speed of the stirring dispersion is preferably 500-1000 r/min, which can be 500 r/min, 550 r/min, 600 r/min, 650 r/min, 700 r/min, 750 r/min, 800 r/min, 850 r/min, 900 r/min, 950 r/min or 1000 r/min in the embodiments of the present disclosure. The present disclosure uses the decentralized treatment to avoid the agglomeration of magnesium hydroxide and biomass calcium material powder. Through a synergistic effect of magnesium hydroxide and the waste slag of aluminum factory, the flame-retardant properties, tensile strength and elongation of the fireproof and flame-retardant material based on the waste slag of aluminum factory are enhanced.

In the present disclosure, the drying preferably includes one or more of room temperature drying, atmospheric heating drying and vacuum heating drying. In the present disclosure, a temperature of room temperature drying is preferably room temperature, and the time is preferably 10-60 min, which can be 10 min, 15 min, 20 min, 25 min, 30 min, 35 min, 40 min, 45 min, 50 min, 55 min or 60 min in the embodiments of the present disclosure. In the present disclosure, a temperature of the atmospheric heating drying is preferably 30-90° C., which can be 30° C., 35° C., 40° C., 45° C., 50° C., 55° C., 60° C., 65° C., 70° C., 75° C., 80° C., 85° C. or 90° C. in the embodiments of the present disclosure; and a time of the atmospheric heating drying is preferably 5-30 min, which can be 5 min, 10 min, 15 min, 20 min, 25 min or 30 min in the embodiments of the present disclosure. In the present disclosure, a temperature of the vacuum heating drying is preferably 30-90° C., which can be 30° C., 35° C., 40° C., 45° C., 50° C., 55° C., 60° C., 65° C., 70° C., 75° C., 80° C., 85° C. or 90° C. in the embodiments of the present disclosure; and a time of the vacuum heating drying is 5-30 min, which can be 5 min, 10 min, 15 min, 20 min, 25 min or 30 min in the embodiments of the present disclosure.

The present disclosure provides applications of the fireproof and flame-retardant material based on the waste slag of aluminum factory described in the above technical solution or the fireproof and flame-retardant material based on the waste slag of aluminum factory prepared by the preparation method described in the above technical solution. The fireproof and flame-retardant material based on the waste slag of aluminum factory provided by the present disclosure is prepared by steps including ball milling, mixing, coating and drying steps. The prepared fireproof and flame-retardant material based on the waste slag of aluminum factory has excellent mechanical properties, flame-retardant properties and tensile strength. The production process is simple, the raw materials are easy to obtain, the environment is friendly, and the cost is low. It has a good application prospect as cable tapes.

The present disclosure further provides a flame-retardant cable, including a cable matrix and the fireproof and flame-retardant material based on the waste slag of aluminum factory coated on a surface of the cable matrix. In the present disclosure, a material of the cable matrix preferably includes glass fiber cloth. A thickness of the fireproof and flame-retardant material based on waste slag of aluminum factory is preferably 0.16-0.22 mm, which can be 0.16 mm, 0.17 mm, 0.18 mm, 0.19 mm, 0.2 mm, 0.21 mm or 0.22 mm in the embodiments of the present disclosure.

The present disclosure provides a preparation method of the lame-retardant cable described in the above technical solution, including the following steps: decentralized treatment is performed on the raw materials of the fireproof and flame-retardant material based on the waste slag of aluminum factory described in the above technical solution, to obtain a mixed solution, and the mixed solution is coated on the cable matrix and dried, to obtain the flame-retardant cable.

In the present disclosure, the coating preferably includes dip-coating and/or bar-coating. In the present disclosure, a number of the dip-coating is preferably 1-4 times, which can be 1 time, 2 times, 3 times or 4 times in the embodiments of the present disclosure; and a time of single dip-coating is preferably 3-10 min, which can be 3 min, 4 min, 5 min, 6 min, 7 min, 8 min, 9 min or 10 min in the embodiments of the present disclosure. In the present disclosure, a number of the bar-coating is preferably 1-4 times, which can be 1 time, 2 times, 3 times or 4 times in the embodiments of the present disclosure; and a thickness of single dip-coating is preferably 10-200 μm, which can be 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm or 200 μm. in the embodiments of the present disclosure.

In the present disclosure, conditions of the decentralized processing and drying are the same as those of the mixing and drying of the fireproof and flame-retardant material based on the waste slag of aluminum factory, which do not be repeated here.

In order to further illustrate the present disclosure, the following is a detailed description of a fireproof and flame-retardant material based on waste slag of aluminum factory, a preparation method and applications thereof, and a flame-retardant cable and a preparation method thereof provided by the present disclosure in combination with the embodiments.

In the following embodiments, a preparation method of dry powder of the waste slag of aluminum factory: the waste slag of aluminum factory is placed in a freezing drier, freeze-dried at −44° C. and 20 Pa for 12 h, ground and refined, to obtain the dry powder of waste slag of aluminum factory with the particle size of 0.074-0.45 mm.

### Embodiment 1

5 phr dry powder of waste slag of aluminum factory, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory.

### Embodiment 2

3.33 phr dry powder of waste slag of aluminum factory, 1.67 phr magnesium hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory/magnesium hydroxide.

### Embodiment 3

2.5 phr dry powder of waste slag of aluminum factory, 2.5 phr magnesium hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory/magnesium hydroxide.

### Embodiment 4

1.67 phr dry powder of waste slag of aluminum factory, 3.33 phr magnesium hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory/magnesium hydroxide.

### Embodiment 5

1.67 phr dry powder of waste slag of aluminum factory, 3.33 phr aluminum hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory/aluminum hydroxide.

### Embodiment 6

1.67 phr dry powder of waste slag of aluminum factory, 3.33 phr Mg—Al layered double hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory/Mg—Al layered double hydroxide.

### Embodiment 7

1.67 phr dry powder of waste slag of aluminum factory, 3.33 phr Ni—Al layered double hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of waste slag of aluminum factory/Ni—Al layered double hydroxide.

### Contrast Example 1

5 phr magnesium hydroxide, 40 phr water, and 4 phr VAE latex were added, ultrasound at 100 W for 30 min, then stirred in a magnetic stirrer at 800 r/min for 1 h, to obtain a mixed solution, the mixed solution was coated on a glass fiber cloth (thickness of 0.15 mm) using a high-precision linear coating device (25 μm), and then heated and dried at 80° C. for 10 min at atmospheric pressure; the above drying process after coating was repeated for a total of 3 times, to obtain a flame-retardant tape of magnesium hydroxide.

### Test Example 1

### Performance Evaluation

The flame retardant, oxygen index, gram weight and mechanical properties of the flame-retardant tapes prepared by the embodiments and the contrast example were tested.

1. Flame retardant test: an oxygen index was measured in an oxygen index tester, i.e. under specified conditions, a minimum oxygen concentration required for the flame combustion of the material in the oxygen-nitrogen mixed gas flow, and the lower a limiting oxygen index (LOI) was, the easier the material was to burn.

2. Thickness and gram weight test: the tapes were cut into a circle with a diameter of 10 cm, and the thickness and gram weight of the tapes were tested.

3. Mechanical property test: the tapes were cut into 250 mm×40 mm strip samples and tested on a universal tensile testing machine at 50 mm/min.

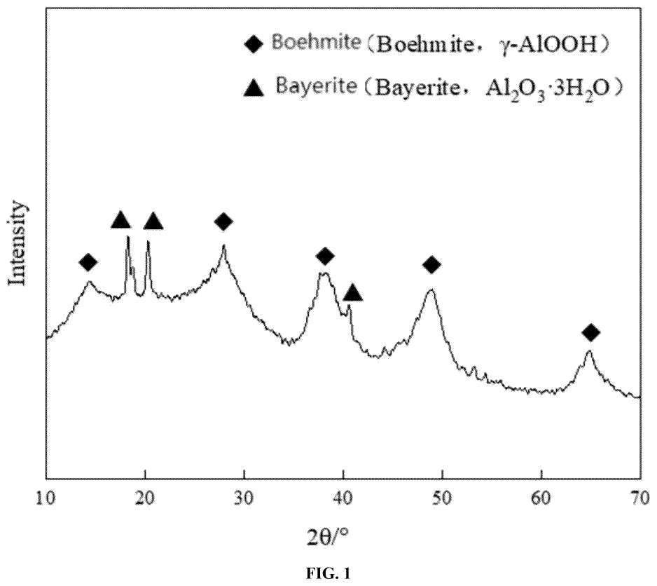

FIG. 1 showed an X-ray diffraction pattern of the waste slag of aluminum factory used in the embodiments. It could be seen from FIG. 1 that the waste slag of aluminum factory mainly included boehmite and bayerite. Boehmite and bayerite were highly insulating substances that could effectively improve the insulation properties of the tapes. In addition, the waste slag of aluminum factory could release a large amount of water when it was thermally decomposed, which could effectively dilute the concentration of combustible gas and reduce the combustion effect of combustible gas. At the same time, Al₂O₃ produced by boehmite decomposition was a dense fire-resistant material, which could cover the surface of the material, and combined with carbon to form a dense protective layer, which inhibited the production of combustible gas, and played the role of heat insulation and oxygen isolation, thereby achieving the effect of flame retardant and smoke suppression. This dual role made the waste slag of aluminum factory an effective flame-retardant material.

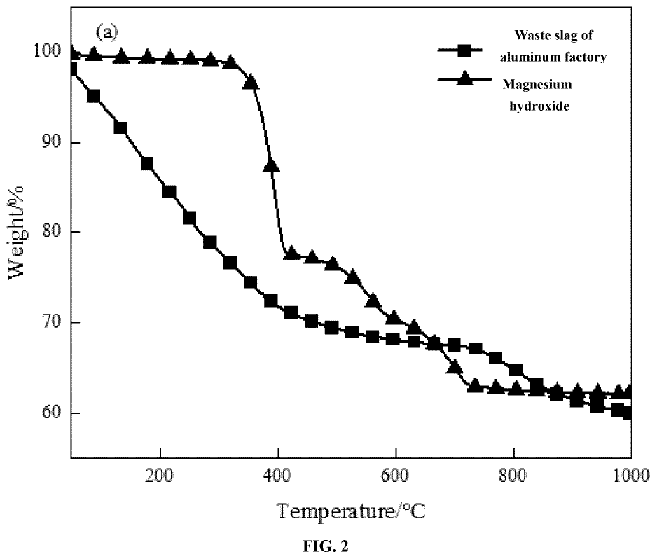

FIG. 2 showed thermogravimetric curves of waste slag of aluminum factory and magnesium hydroxide. It could be seen from FIG. 2 that the waste slag of aluminum factory could undergo decomposition in a wide temperature range, and magnesium hydroxide began to be decomposed at 300° C., residual solids of the waste slag of aluminum factory and magnesium hydroxide were more than 50 wt % at 1000° C., which indicated that the waste slag of aluminum factory and magnesium hydroxide could effectively exert gas-phase flame retardant and cohesive flame retardant mechanisms.

TABLE 1
Performance test results of flame-retardant tapes
prepared by embodiments and contrast example

| | | | Gram | Tensile | |
|---|---|---|---|---|---|
| | LOI/ | Thickness/ | weight/ | strength/ | Elongation/ |
| Sample | % | mm | (g/m²) | MPa | % |
| Embodiment 1 | 90 | 0.16-0.18 | 187 | 143.49 | 6.11 |
| Embodiment 2 | 100 | 0.17-0.19 | 191 | 136.27 | 5.69 |
| Embodiment 3 | 100 | 0.17-0.19 | 193 | 126.27 | 5.55 |
| Embodiment 4 | 100 | 0.18-0.19 | 198 | 142.18 | 5.93 |
| Embodiment 5 | 100 | 0.17-0.19 | 198 | 140.24 | 5.83 |
| Embodiment 6 | 100 | 0.18-0.20 | 200 | 139.67 | 5.80 |
| Embodiment 7 | 100 | 0.18-0.19 | 199 | 141.96 | 5.79 |
| Contrast | 100 | 0.18-0.20 | 203 | 145.15 | 5.65 |
| Example 1 | | | | | |

It could be seen from Table 1 that flame-retardant tapes of Embodiments 1-4 had a high oxygen index, which was higher than 90%, and were extremely difficult to burn. In the case of maintaining a high oxygen index, the tensile strength and tensile rate of the flame-retardant tape of Embodiment 4 were better than those of other compounding ratios, and then its gram weight and thickness were similar to those of other compounding ratios. Therefore, Embodiment 4 was the best compounding ratio, so the power of waste slag of aluminum factory was compounded with different hydroxides according to the same ratio of Embodiment 4, to prepare Embodiments 5-7.

Under the same ratio, different hydroxides were compounded with the waste slag of aluminum factory to obtain Embodiments 4-7. Examples 4-7 were compared on the effects of different hydroxides combining with the waste slag of aluminum factory on the performance of flame-retardant tapes. It could be seen that Embodiment 4 had high oxygen index, low gram weight, high tensile strength and elongation, with the best comprehensive performance. Therefore, from the perspective of all the properties of the tape, the flame-retardant tape of the waste slag of aluminum factory/magnesium hydroxide of Embodiment 4 had the best performance, with the characteristics of lightweight, high mechanical properties and high flame retardant.

Embodiment 1 was compared with Contrast Example 1 on the performance of flame retardant tapes with only waste slag of aluminum factory and only magnesium hydroxide at the same adding amount. It could be seen that the gram weight and elongation of Embodiment 1 were 187 g/m² and 6.11%, respectively, which were better than that of Contrast Example 1. The oxygen index and tensile strength of Embodiment 1 were 90% and 143.49 MPa, respectively, which were similar to that of Contrast Example 1. Therefore, considering all the properties of the tape, the flame-retardant tape of Embodiment 1 had the best performance, with the characteristics of lightweight, high mechanical properties and high flame retardant.

The above descriptions are only the preferred embodiments of the present disclosure. It is to be pointed out that those of ordinary skill in the art can also make several improvements and modifications without departing from the principle of the present disclosure, and such improvements and modifications shall fall within the protection scope of the present disclosure.

What is claimed is:

1. A fireproof and flame-retardant material based on a waste slag of an aluminum factory, comprising: in weight parts, raw materials as follows: 1-6 phr of the waste slag of the aluminum factory, 0-6 phr of an inorganic hydroxide, 3-8 phr of a vinyl acetate-ethylene (VAE) latex, and 20-50 phr of water wherein the waste slag of the aluminum factory is measured by a dry weight.

2. The fireproof and flame-retardant material according to claim 1, wherein a component of the waste slag of the aluminum factory comprises one or more of boehmite, bayerite, α-alumina, and β-alumina;
the waste slag of the aluminum factory is dehydrated and dried before use, and then crushed and refined to obtain a dried powder of the waste slag of the aluminum factory; and
a particle size of the dried powder of the waste slag of the aluminum factory is 0.074-0.45 mm.

3. The fireproof and flame-retardant material according to claim 1, wherein the inorganic hydroxide comprises one or more of magnesium hydroxide, aluminum hydroxide, a Mg—Al layered double hydroxide, and a Ni—Al layered double hydroxide.

4. A preparation method of the fireproof and flame-retardant material according to claim 1, comprising the following steps: performing a decentralized treatment on the raw materials to obtain a mixed solution, and drying the mixed solution to obtain the fireproof and flame-retardant material.

5. The preparation method according to claim 4, wherein the decentralized treatment comprises an ultrasonic dispersion and/or a stirring dispersion;
a time of the ultrasonic dispersion is 15-60 min, and a power of the ultrasonic dispersion is 80-120 W; and
a time of the stirring dispersion is 0.5-3 min, and a speed of the stirring dispersion is 500-1000 r/min.

6. The preparation method according to claim 4, wherein the drying comprises one or more of a room temperature drying, an atmospheric heating drying, and a vacuum heating drying;
a time of the room temperature drying is 10-60 min;
a temperature of the atmospheric heating drying is 30-90° C., and a time of the atmospheric heating drying is 5-30 min; and
a temperature of the vacuum heating drying is 30-90° C., and a time of the vacuum heating drying is 5-30 min.

7. The fireproof and flame-retardant material according to claim 1, wherein the fireproof and flame-retardant material is used in a tape of an electrical cable.

8. A flame-retardant cable, comprising a cable matrix and the fireproof and flame-retardant material according to claim 1, wherein the fireproof and flame-retardant material is coated on a surface of the cable matrix.

9. A preparation method of the flame-retardant cable according to claim 8, comprising the following steps:
performing a decentralized treatment on the raw materials of the fireproof and flame-retardant material to obtain a mixed solution, and coating the mixed solution on the cable matrix and drying to obtain the flame-retardant cable.

10. The preparation method according to claim 9, wherein the decentralized treatment comprises an ultrasonic dispersion and/or a stirring dispersion;
a time of the ultrasonic dispersion is 15-60 min, and a power of the ultrasonic dispersion is 80-120 W; and
a time of the stirring dispersion is 0.5-3 min, and a speed of the stirring dispersion is 500-1000 r/min; and
the drying comprises one or more of a room temperature drying, an atmospheric heating drying, and a vacuum heating drying.

11. The preparation method according to claim 4, wherein in the fireproof and flame-retardant material, a component of the waste slag of the aluminum factory comprises one or more of boehmite, bayerite, α-alumina, and β-alumina;
the waste slag of the aluminum factory is dehydrated and dried before use, and then crushed and refined to obtain a dried powder of the waste slag of the aluminum factory; and
a particle size of the dried powder of the waste slag of the aluminum factory is 0.074-0.45 mm.

12. The preparation method according to claim 4, wherein in the fireproof and flame-retardant material, the inorganic hydroxide comprises one or more of magnesium hydroxide, aluminum hydroxide, a Mg—Al layered double hydroxide, and a Ni—Al layered double hydroxide.

13. The fireproof and flame-retardant material according to claim 2, wherein the fireproof and flame-retardant material is used in a tape of an electrical cable.

14. The fireproof and flame-retardant material according to claim 3, wherein the fireproof and flame-retardant material is used in a tape of an electrical cable.

15. The flame-retardant cable according to claim 8, wherein in the fireproof and flame-retardant material, a component of the waste slag of the aluminum factory comprises one or more of boehmite, bayerite, α-alumina, and β-alumina;
the waste slag of the aluminum factory is dehydrated and dried before use, and then crushed and refined to obtain a dried powder of the waste slag of the aluminum factory; and
a particle size of the dried powder of the waste slag of the aluminum factory is 0.074-0.45 mm.

16. The flame-retardant cable according to claim 8, wherein in the fireproof and flame-retardant material, the inorganic hydroxide comprises one or more of magnesium hydroxide, aluminum hydroxide, a Mg—Al layered double hydroxide, and a Ni—Al layered double hydroxide.
